(19) United States
(12) Patent Application Publication
(10) Pub. No.: US 2006/0136738 A1
(43) Pub. Date: Jun. 22, 2006

(54) System and method for password validation

(75) Inventors: Frederic Bauchot, La Tourraque (FR); Gerard Marmigere, Drap (FR)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/255,313

(22) Filed: Oct. 20, 2005

(30) Foreign Application Priority Data
Dec. 16, 2004 (EP) 04300904.2

(51) Int. Cl. H04L 9/00

(52) U.S. Cl. 713/183

(57) ABSTRACT

A method and system for password validation. A user identifier (ID), a user password, and a sequence of user values are received from a user. The user password consists of plain text characters. The sequence of user values consists of at least one non plain-text parameter associated with each plain-text character of the user password. The user password is appended to the sequence of user values to form a user password string. The user password string is hashed to form a user digest. It is determined whether the user digest is equal to a reference digest. The reference digest is configured in accordance with password validation rules. The password validation rules specify an expected value for the at least one non plain-text parameter associated with each plain-text character of the user password.

### BACKGROUND OF THE INVENTION

1. Technical Field

The present invention relates generally to computer system security, and more particularly to a system and method to check user password validity when accessing computer systems resources.

2. Related Art

Prompting a user password controls access of a user to many different types of computer resources. Entry of a password may be required to log-on to a network or a host, to open a standalone application, or to access certain data. Entry of a correct password may be sufficient to grant a user access to a data processing system. Alternatively, the user may be known to the data processing system by a unique userid (ID) and that unique userid may have a unique password associated with it. To gain access to the data processing system, the user first enters the user's userid and then enters the user's password. A scenario for specifying a userid and a password is shown in FIG. 1, in accordance with the prior art.

A user 101 interacts with a computer system 100 comprising an output device 102 (typically, a display), an input device 103 (typically, a keyboard and/or a pointing mouse), a local software program called ‘agent’ 104 to handle the password exchange between the input device 103 or the output device 102 and an application to be accessed, and a software program called ‘application’ 105 that the user requests to access.

In a first step 110, the user 101 issues a registration request towards the application 105 via the input device 103, and relayed by the agent 104.

In a second step 111, the application 105 prompts the user 101 for providing an identifier (denoted ID) and an associated password. This prompt is relayed by the agent 104 before being posted on the output device 102.

In a third step 112, the user 101 provides the required ID and password, still relying on the input device 103 and agent 104.

In a fourth step 113, the application 105 validates the received ID and password; e.g., through a reference table look-up.

In a fifth step 114, the application 105 grants registration to the user 101. This granting is relayed by the agent 104 before being posted on the output device 102.

Afterwards, a trusted user/application transaction 115 may follow this registration procedure.

In this scenario, the human-machine interaction 120 takes place between the user 101 and either the output device 102 (when the user is receiving information) or the input device 103 (when the user is providing information). In the later case, the retrieval of the data 121 specified by the user is done under the control of the agent 104 through the input device 103. Information retrieved by the agent 104 can afterwards be shared with the application 105, regardless of the fact that the agent and the application are proximate or not. In the typical case where the application is remote from the agent, security 122 is exposed between the agent 104 and the application 105, as eyes droppers may try to tap the agent-application information exchange.

A problem in the previous scenario, and more precisely at step 112, is that the exchange of the sensitive information (ID and password) from the agent 104 to the application 105 does not depend on the way the information has been retrieved by the agent 104, but only on the value of this information. Moreover, the verification 113 of the specified information is solely done by the application 105.

A consequence is that some password related information is not used to further validate the correctness of the ID and password and that the information validation is done after the information exchange, which is subject to security risks.

Thus, there is a need for improving security associated with the validation of passwords.

### SUMMARY OF THE INVENTION

The present invention provides a computer implemented method for password validation, said method comprising:

receiving, from a user, a user identifier (ID), a user password, and a sequence of user values, the user password consisting of plain text characters, the sequence of user values consisting of at least one non plain-text parameter associated with each plain-text character of the user password;

appending the user password to the sequence of user values to form a user password string;

hashing the user password string to form a user digest; and

determining whether the user digest is equal to a reference digest, said reference digest being configured in accordance with password validation rules, said password validation rules specifying an expected value for said at least one non plain-text parameter associated with each plain-text character of the user password.

The present invention provides a computer-implemented system for password validation, said computer system comprising:

means for receiving, from a user, a user identifier (ID), a user password, and a sequence of user values, the user password consisting of plain text characters, the sequence of user values consisting of at least one non plain-text parameter associated with each plain-text character of the user password;

means for appending the user password to the sequence of user values to form a user password string;

means for hashing the user password string to form a user digest; and

means for determining whether the user digest is equal to a reference digest, said reference digest being configured in accordance with password validation rules, said password validation rules specifying an expected value for said at least one non plain-text parameter associated with each plain-text character of the user password.

The present invention provides a computer program product, comprising a computer usable medium having a computer readable program that when executed on a computer causes the computer to perform a method for password validation, said method comprising:

receiving, from a user, a user identifier (ID), a user password, and a sequence of user values, the user password consisting of plain text characters, the sequence of user values consisting of at least one non plain-text parameter associated with each plain-text character of the user password;

appending the user password to the sequence of user values to form a user password string;

hashing the user password string to form a user digest; and

determining whether the user digest is equal to a reference digest, said reference digest being configured in accordance with password validation rules, said password validation rules specifying an expected value for said at least one non plain-text parameter associated with each plain-text character of the user password.

The present invention advantageously improves security associated with the validation of passwords.

### BRIEF DESCRIPTION OF THE DRAWINGS

FIG. 1 is a general data flow exchange to specify a user ID and password to access a computer resource, in accordance with the prior art.

FIG. 2 is a general data flow exchange to specify a user ID and password to access a computer resource, in accordance with the present invention.

FIG. 3 is a detailed view of the data flow exchange of FIG. 2, in accordance with the present invention.

FIG. 4 illustrates a rules definition table, in accordance with the present invention;

FIG. 5 shows a Binary Encoded Test example, in accordance with the present invention.

FIG. 6 shows a String Encoded Result example, in accordance with the present invention.

FIG. 7 is an example of a digest, in accordance with the present invention.

### DETAILED DESCRIPTION OF THE INVENTION

A method for checking the validity of a user password is disclosed. The method preferably operates in a computer system environment wherein password validation rules are created by a user. For each plain-text character of a user password an expected value for at least one non plain-text parameter is defined, the expected value being chosen from a predefined list of possible values. The password validation rules are next encoded into a binary codes sequence, and a password validation string is created by appending the user password to the encoded expected values of the binary codes sequence. A hash function is then performed on the password validation string to generate a digest password. Upon reception of a user request to get access to an application, the user is requested to enter a user identifier and a user password. A verification is made each plain-text character is entered in the way as defined by the password validation rules. In case of matching, a further checking of the user identifier and the plain-text characters of the user password against an identifier/password reference is then made. Finally, access is granted to the application if the user identifier and the user password match the identifier/password reference, otherwise access is denied.

The present invention achieves provides a method and system for proofing the identity of a user through enhanced password validation.

The present invention validates a user specified password against a digest by taking into account the way the password has been specified on top of the password value.

The present invention defines an internal machine readable representation of test conditions during a password characters acquisition.

The present invention defines a method aimed to record and validate the way a password has been specified by a user, against a predefined reference.

The present invention defines a protocol based on the exchange of messages to allow an application party to receive from an agent party a password along with a proof that the way the password has been specified is as expected.

The present invention provides a method for checking the validity of a user password.

A “plain text character is a character that when selected is embodied as a generated character shape generated (e.g., an alphanumeric character such as “a”, “Z”, “9” or non alphanumeric characters such as “%”, “!”, etc.). A plain text character is selected or keyed by depressing the corresponding key of the keyboard.

The method of the present invention operates in a computer system environment wherein password validation rules are created by a user. For each plain-text character of a user password, an expected value for at least one non plain-text parameter is defined, the expected value being chosen from a predefined list of possible values. A non plain-text parameter denotes a state of a non plain-text parameter of an input device.

For a keyboard, examples of non plain-text parameters include the state of the Caps Lock key, Shift key, etc. A non plain-text parameter of a keyboard is selected or keyed by depressing a non-plain character key of the keyboard (e.g., by depressing the Caps Lock key to change the state of the Caps Lock key to “ON” or “OFF”).

For a mouse, examples of non plain-text parameters include the presence of the mouse above the cursor (“UP”), the presence of the mouse below the cursor (“DOWN”), the presence of the mouse to the right of the cursor (“RIGHT”), and the presence of the mouse to the left of the cursor (“LEFT”). A non plain-text parameter of a keyboard is selected by moving the mouse to the position associated with the keying character (e.g., above the cursor) or leaving the mouse in place if the mouse is already at the position of the keying character.

The password validation rules are next encoded into a binary codes sequence, and a password validation string is created by appending the user password to the encoded expected values of the binary codes sequence. A hash function is then performed on the password validation string to generate a digest password. Upon reception of a user request to get access to an application, the user is requested to enter a user identifier and a user password. A verification is made to ensure that each plain-text character is entered in the way as defined by the password validation rules. In case of matching, a further checking of the user identifier and the plain-text characters of the user password against an identifier/password reference is then made. Finally, access is granted to the application if the user identifier and the user password match the identifier/password reference; otherwise access to the application is denied.

In a commercial form, computer readable program means allowing a computer machine to perform the method of the present invention are embodied on a program storage device that is readable by the computer machine.

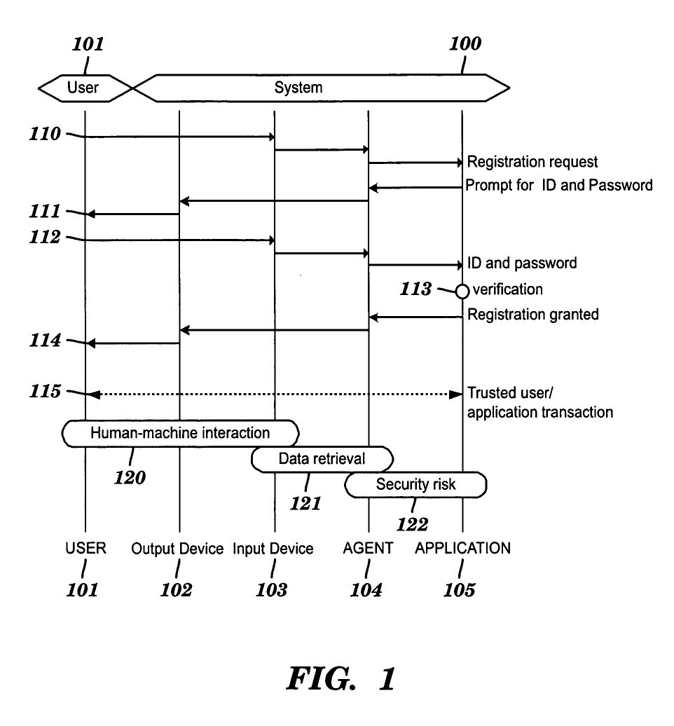

The present invention takes advantage of two characteristics: (1) a password is not only characterized by its value, but also by the way this value is specified, with respect to the different input devices available to the user; and (2) password validation is not only done by the entity granting the user registration (i.e., the application entity 105 in the former scenario of FIG. 1), but also by the entity interacting with the user for password exchange (i.e., the agent entity 104 in the former scenario of FIG. 1).

For clarifying the description, the term “password keying” (or PK for short) is used in the description herein to represent the way the password is specified by the user 101 to the input device 103. This PK relates clearly to the nature or state of the input device used to specify the password, such as a keyboard, a pointing device like a mouse or a graphical tablet, etc.

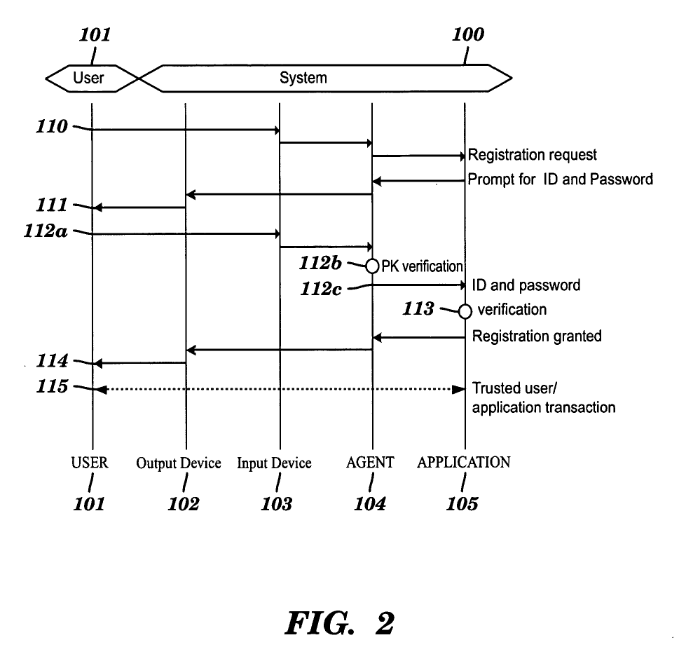

According to the proposed invention, the new password validation scenario is illustrated on FIG. 2, in accordance with the present invention. Initial steps 110 and 111 remain identical as those previously described for FIG. 1. Step 112 of FIG. 1 is divided in FIG. 2 into three steps: 112a, 112b, and 112c.

In step 112a, the user 101 specifies the information to the agent 104 through the input device 103. The agent 104 then checks for each character of the password entered the keying followed by the user while specifying the password. This local validation of the keying is done against a known password keying reference that has been previously entered by the user at the time of password definition and passed to the agent 104.

In step 112b, a verification is done by the agent 104 to verify that all characters have been entered in a correct way. At the end of password keying, if all the characters have been entered in the way described by the keying reference, then a last step 112c is followed. Otherwise the user 101 is notified that the password was incorrectly specified (although its value may be valid).

In step 112c, the application 105 receives the ID and password specified by the user 101.

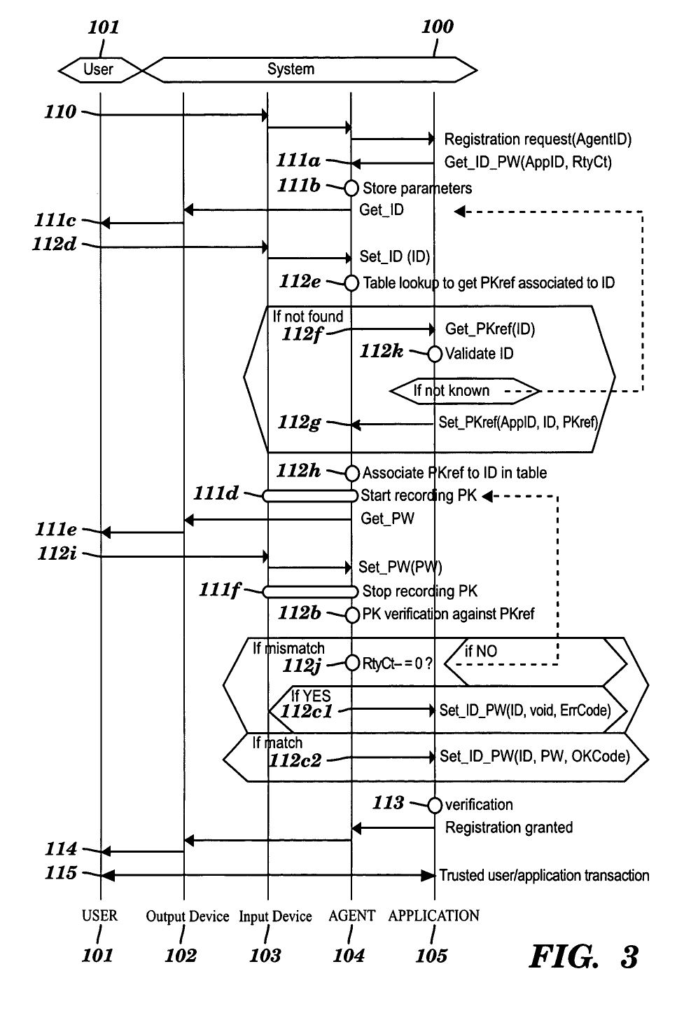

The further steps 113 to 115 remain identical to those previously described for FIG. 1. More details of the general scenario of the present invention will be described infra with reference to FIG. 3.

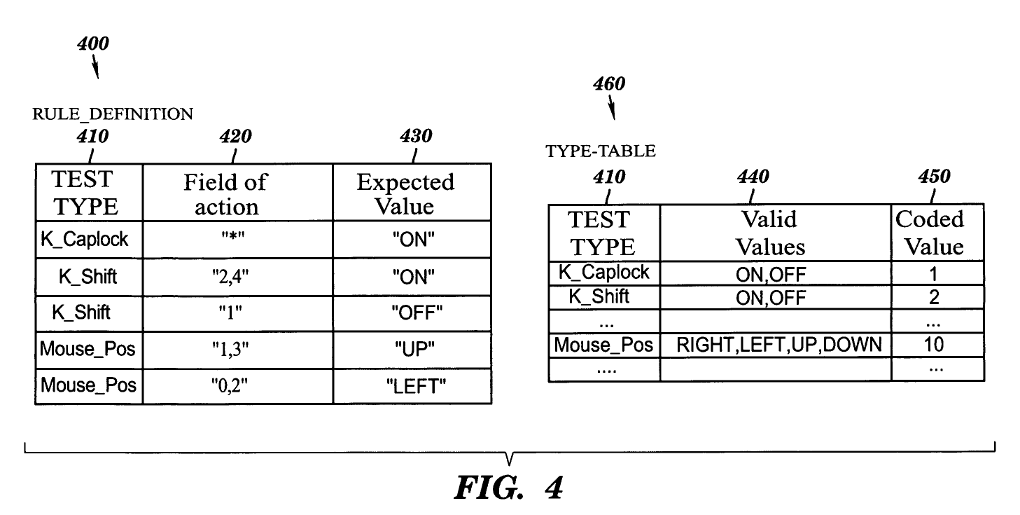

In accordance with the present invention, a dedicated ‘keying’ button is added to a Graphical User Interface, such as the user definition window from Microsoft Windows. By pressing the “keying” button, a dialog box is open which allows the user to define or modify the rules governing the password keying. The rules are defined in a “RULE_DEFINITION” table 400 as shown on FIG. 4, in accordance with the present invention. Each element of the table 400 is defined by three items: a “TEST TYPE” 410, a “Field of Action” 420, and an “Expected Value” 430. The preceding three items represent a rule to be checked during the password keying.

The first column “TEST TYPE” 410 defines the element to be tested. The content of this field refers to elements which are predetermined in a “TYPE_TABLE” table 460 as illustrated on FIG. 4.

The second column Field of Action 420 defines the position of the character(s) of the password on which the rule is to be applied. In an embodiment, this field is represented as a character string where:

a “,” character represents a separator between character identifications; e.g., “3,5” for a rule to be applied to characters at position 3 and 5 in the password;

a “*” character indicates that the rule is to be applied to all characters; and

a “-” character represents a separator between two characters positions to indicate a range of character positions to which the rule is to be applied. For example, “2-5” indicates that the rule is to be applied to characters being at positions 2,3,4 and 5.

If either the first value or the last value in a range is not specified, then the value ‘0’ is taken to replace the omitted first value and the value ‘password length -1’ is taken to replace the omitted last value. For example a value “-2” is equivalent to “0-2” or “0,1,2”. In the same manner for a password having six characters of length, a value “3-” is equivalent to “3-5” or “3,4,5”.

The last (i.e., third) column of table 400, namely “Expected Value” 430, specifies the value that is expected when the test defined by the rule is executed. Some examples of valid values (ON,OFF,RIGHT, . . . ) are listed in column 440 of the “TYPE-TABLE” 460 for each TEST_TYPE. The “Coded Value” 450 column denotes the value of the Test Type 410.

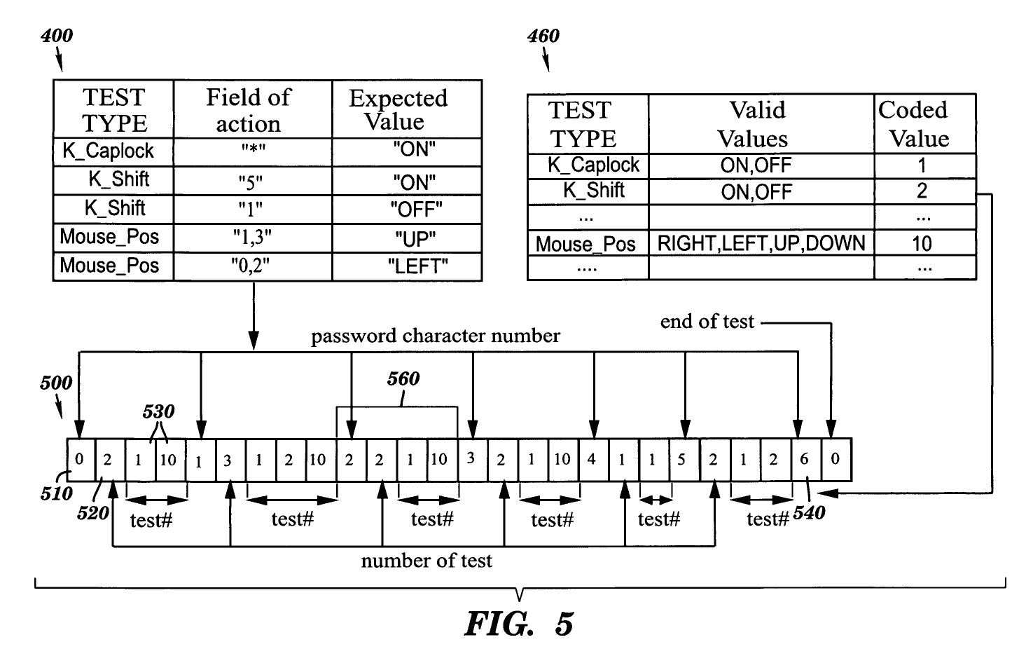

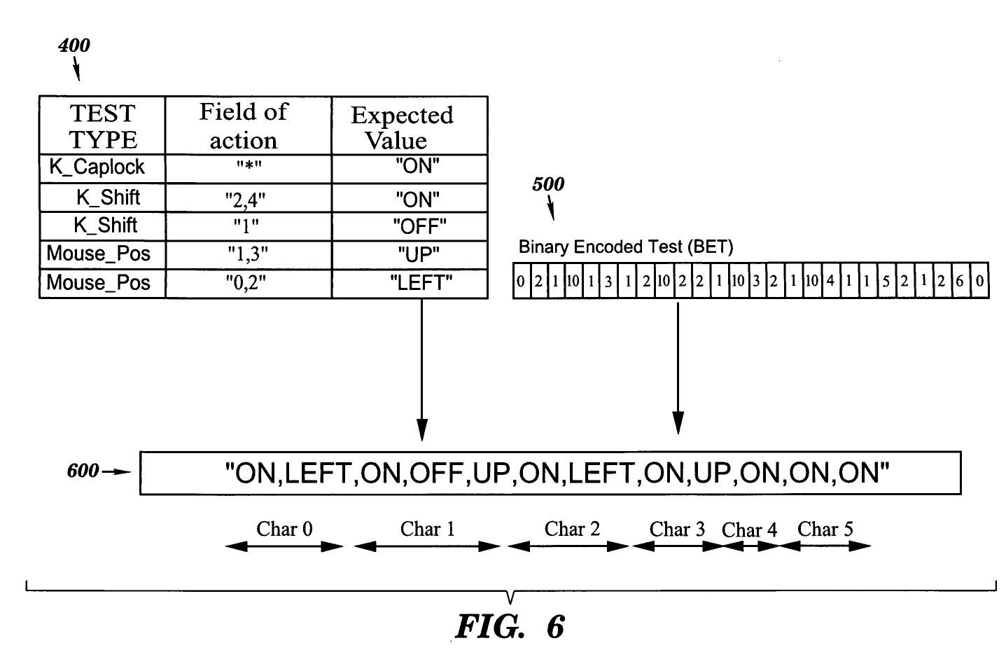

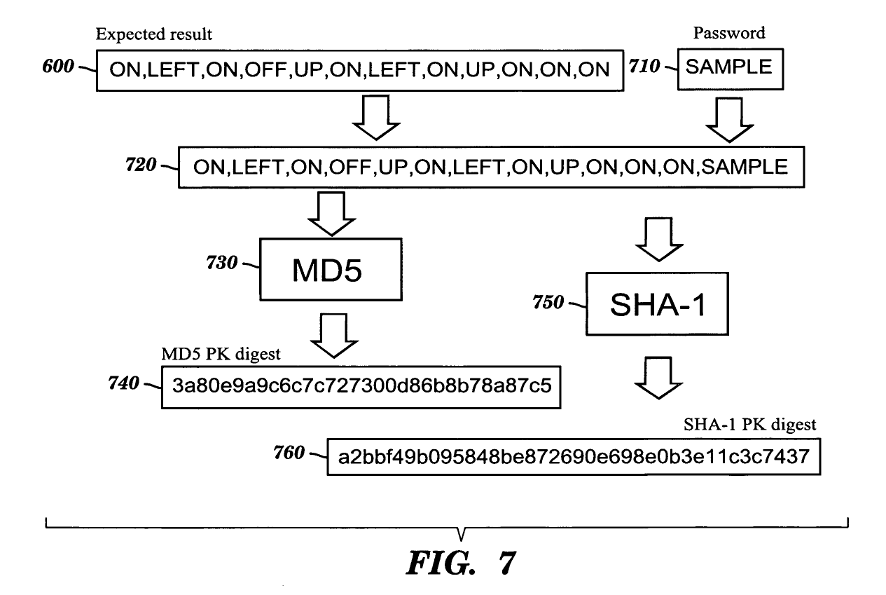

After having defined the user's password and the rules to govern it, the user resumes the process. To operate the process, a dedicated “create” button may be added to the user interface. The rules and the expected values as specified by the user are first respectively translated in a Binary Encoded Test (BET) 500 (see FIG. 5) and in a String Encoded Result (SER) 600 (see FIG. 6). The specified password is then appended to the SER to create either a Digest 730 or a Password Fingerprint 750500 (see FIG. 7).

A message digest function is an algorithm which takes a variable-length message and produces as output a “fingerprint” or a “message digest”. The output is a fixed-length hash of 128 bits for the Digest (See: “The MD5 Message-Digest Algorithm” RFC 1321 from R. Rivest), or of 160 bits for the Fingerprint SHA-1 (See “Secure Hash Algorithm 1” RFC 3174). The advantage of using a hash function is that it is computationally all but impossible to find another message having the same hash. In fact one can't determine any usable information about a message from the hash, not even a single bit. One can't determine any usable information about a message from the hash, not even a single bit. The idea is if a message digest is computed, then if any byte in the message changes, the next-computed message digest will change and the tampering can be detected when the hash is computed again. If there is no tampering, the digest will remain constant.

The Binary Encoded Test (BET) 500 as shown on FIG. 5 is an array of characters which is a computer readable representation of the tests to be executed on each character of the password during the password keying. The array contains (N+1) Character_Test_Array fields 560 (CTA), where N is the password length in bytes. CTA is structured by byte sequences as follows:

a first byte 510 represents the character number of the password. The password characters are numbered from left to right starting from 0. For a password “SAMPLE”, the first letter “S” is the character “0” while the last letter “E” is the character “5”;

a second byte 520 represents the number of tests defined for the password character specified in the first byte;

from the third to the ‘number of tests defined’ (value of the 2nd byte +2) 530, each byte is filled with a test number (i.e., “Coded Value” 450) associated to a TEST-TYPE of the TYPE_TABLE table 460 in FIG. 5.

In consideration of the content of tables 400 and 460, the first CTA byte sequence of 0,2,1,10 denotes that for the first letter “S” of the password “SAMPLE”, there are 2 tests corresponding to Coded Values of 1 (i.e., K_Caplock) and 10 (i.e., Mouse Position) with expected values of “ON” and “LEFT”, respectively. The second CTA byte sequence of 1, 3, 1, 2, 10 contains the information associated to the second character “A” of the password “SAMPLE”. The last CTA byte “0” of the BET is used to indicate the end of the BET.

In FIG. 6, a SER 600 is shown as a string comprising the expected values as specified in table 400 appended in their order of test apparition in the Binary Encoded Test (BET) 500. In the SER 600, the sequence of expected values of the non plain-text parameter is ordered sequentially in accordance with the sequential ordering of the plain-text characters of the user password.

The result expected on each test performed on the password character is encoded separately.

In order to hide and prevent any reconstitution of either the results expected on the tests or of the password itself, a digest is created as shown on FIG. 7. The digest is issued from a new string 720, called a “validation password string”, resulting from a concatenation of the SER 600 and the password 710 (i.e., from the SER 600 to which the password 710 has been appended). This validation password string is processed by a digest algorithm. The algorithm may be either a MD5 one 730 or a SHA-1 one 750 to produce respectively a MD5 PK Digest 740 or a SHA-1 PK digest 760. The resulting digest (740 or 760) is then saved as a password keying reference digest PKref.

It is to be appreciated that alternatively any other hashing method can be used instead of the MD5 or the SHA-1 ones without departing from the spirit of the present invention.

Reference is now made back to FIG. 3 to better describe the password keying validation on a more detailed and generic scenario addressing different conditions that could happen along the ID and password exchange.

In step 110, the user 101 issues a registration request towards the application 105, built by the input device 103, and relayed by the agent 104.

In step 111a, the application 105 sends to the agent 104 a message in the form of “Get_ID_PW(AppID,RtyCt)” for getting the identification and password of the user 101. The application 105 signs its identity through the parameter AppID, and further passes a parameter RtyCt later used in the scenario to limit the number of retries if the password keying verification fails.

In step 111b, the ‘AppID’ and ‘RtyCt’ parameters are stored in an internal memory of the agent computer system.

In step 111c, the agent 104 sends to the user 101 through the output device 102 a request to get the user identification. The user is prompted on a display device in the form of a message “Get_ID” issued by the agent 104.

In step 112d, the user 101 uses the input device 103 to return to the agent 104 the user's identification, formally represented by a message “Set_ID(ID)” sent to the agent 104 in response to the “Get_ID” message.

In step 112e, the agent 104 performs a look-up in an internal table associated with the application identified by the parameter ‘AppID’, to find a record associated to the user identifier, and filled with a reference for password keying, named ‘PKref’ (also called “reference digest”). If this fails, then control is given to step 112f, otherwise control is given to step 111d.

In step 112f, the agent 104 sends to the application 105 a message “Get_PKref(ID)” to get the ‘PKref’ parameter associated to the user identified by the ID parameter (because this information has not been found in the internal tables of the agent 104).

In step 112k, the application validates if the received ID is known. If it is the case, then the control is given to step 112g, otherwise the process goes back to step 111c.

In step 112g, the application 105 sends to the agent 104 a message “Set_PKref(AppID, ID, PKref)” in response to the former message.

In step 112h, the agent 104 updates the internal table associated with the application identified by the parameter ‘AppID’ within the record associated to the user identified by the parameter ‘ID’, by filling the reference for password keying field with the parameter ‘PKref’ received at the previous step.

In step 111d, the agent 104 interacts with the input device 103 to start recording the keying of the next-to-come user specified information. For example, in the case where the input device is a conventional keyboard, recording the keying records every hit on any key of the keyboard. This recording operation is done according to the password keying representation previously described.

In step 111e, the agent 104 sends to the user 101 through the output device 102 a request to get the password. This can be as simple as displaying a user prompt on a display device, and is formally represented by a message “Get_PW” issued by the agent 104.

in step 112i, the user 101 uses the input device 103 to return to the agent 104 his/her password character by character. The way the password characters have been entered is checked according to the test defined in the BET and the result is saved in a string according to the value defined in the TYPE-TABLE, formally represented by a message “Set_PW(PW)” sent to the agent 104 in response to the “Get_PW” message.

In step 111f, the agent 104 interacts with the input device 103 to stop recording the keying of the password. The string recorded since step 111d which represents the tests results is represented by the parameter ‘PK’.

In step 112b, the agent 104 appends to the string of results the password entered and calculates “user digest” (e.g., a MD5 or a SHA-1 digest) to verify if the user digest is equal to the reference digest ‘PKref’. If the user digest is not equal to the reference digest, then control is given to step 112j, otherwise control is given to step 112c2.

In step 112j, a retry parameter ‘RtyCt’ is decremented and the resulting value is compared against zero. If found different from zero, then control is given back to step 111d for retrying password retrieval. If found equal to zero, then the maximum number of retries has been exhausted and control is given to step 112c1 for completing unsuccessfully the scenario.

In step 112c1, the agent 104 sends to the application 105 a message “Set_ID_PW(ID, void, ErrCode)” in response to the message received at step 111a. The parameter ‘ErrCode’ specifies that the password keying has failed after having gone through the maximum number of retries, so that there is no password passed in this message (second parameter taking a default void value). The next step of the scenario is step 113.

In step 112c2, the agent 104 sends to the application 105 a message “Set_ID_PW(ID, PW, OKCode)” in response to the message received at step 111a. The parameter ‘OKCode’ specifies that the password keying has been successfully passed, so that there is a password passed in this message (second parameter ‘PW’). The next step of the scenario is step 113.

In step 113, the application 105 validates the received ID and password; e.g., through a reference table look-up. The policies used to execute this step are beyond the scope of the present invention. If the validation step is positive, then the next step is step 114; otherwise the scenario ends.

In step 114, the application 105 grants registration to the user 101. This granting is relayed by the agent 104 before being posted on the output device 102.

Afterwards, a trusted user/application transaction 115 may follow this registration procedure.

It must be noted that the previous scenario does not specifically address the policies followed to update the PKref parameter. This is considered to be outside of the scope of the present invention, and can be implemented by any conventional means, such as the ones currently used for password update management for example.

In an alternate embodiment, in step 111a, an optional ‘PKref’ parameter could be added to allow the application 105 to take advantage of this message to pass to the Agent 104 an update of the ‘PKref’ parameter. This alternative assumes that the application 105 comprises means to identify the current user 101 (for instance through other parameters that may have been passed in the registration request message 110). In this case, the scenario continues, but step 112e is replaced by step 112h to update the table that records the ‘PKref’.

What is claimed is:

1. A computer implemented method for password validation, said method comprising
receiving, from a user, a user identifier (ID), a user password, and a sequence of user values, the user password consisting of plain text characters, the sequence of user values consisting of at least one non plain-text parameter associated with each plain-text character of the user password;
appending the user password to the sequence of user values to form a user password string;
hashing the user password string to form a user digest; and
determining whether the user digest is equal to a reference digest, said reference digest being configured in accordance with password validation rules, said password validation rules specifying an expected value for said at least one non plain-text parameter associated with each plain-text character of the user password.

2. The method of claim 1, wherein said receiving the sequence of user values from the user comprises receiving the sequence of user values from an input device of a computer system of the user, wherein the non plain-text parameters in the sequence of user values consist of non plain-text parameters of the input device, and wherein the input device is a keyboard.

3. The method of claim 1, wherein said receiving the sequence of user values from the user comprises receiving the sequence of user values from an input device of a computer system of the user, wherein the non plain-text parameters in the sequence of user values consist of non plain-text parameters of the input device, and wherein the input device is a mouse.

4. The method of claim 1, wherein an agent distinct from the application performs said receiving, said generating, and said determining.

5. The method of claim 4, wherein the agent and the application are comprised by different computing systems.

6. The method of claim 4, wherein the reference digest is stored in a table of the agent, and wherein the method further comprises:
receiving by the agent an updated reference digest from the application; and
replacing the stored reference digest in the table by the updated reference digest.

7. The method of claim 1, wherein a plurality of non plain-text parameters is associated with a plain-text character of the at least one plain-text character of a user password.

8. The method of claim 1, wherein if said determining determines that the user digest is equal to the reference digest then granting access to the application if it is subsequently ascertained that the user ID and the user password respectively match a reference ID and a reference password.

9. The method of claim 1, wherein the method further comprises:
generating the reference digest by hashing a validation password string derived from said password validation rules, said validation password string comprising the user password appended to a sequence of said expected values, said sequence of said expected values ordered sequentially in accordance with a sequential ordering of the plain-text characters of the user password.

10. The method of claim 9, wherein the validation password string is derived from password validation rules by:
deriving a Binary Encoded Test (BET) array from the password validation rules, wherein the BET array comprises for each plain text character of the user password: a number of tests defined for each said plain-text character, and a coded value identifying one of the non plain-text parameters associated with each said test;
deriving the sequence of expected values from the BET array and the password validation rules; and
appending the user password to the sequence of expected values to form the validation password string.

11. A computer-implemented system for password validation, said computer system comprising:
means for receiving, from a user, a user identifier (ID), a user password, and a sequence of user values, the user password consisting of plain text characters, the sequence of user values consisting of at least one non plain-text parameter associated with each plain-text character of the user password;
means for appending the user password to the sequence of user values to form a user password string;
means for hashing the user password string to form a user digest; and
means for determining whether the user digest is equal to a reference digest, said reference digest being configured in accordance with password validation rules, said password validation rules specifying an expected value for said at least one non plain-text parameter associated with each plain-text character of the user password.

12. The system of claim 11, wherein said means for receiving the sequence of user values from the user comprises means for receiving the sequence of user values from an input device of a computer system of the user, wherein the non plain-text parameters in the sequence of user values consist of non plain-text parameters of the input device, and wherein the input device is a keyboard.

13. The system of claim 11, wherein said means for receiving the sequence of user values from the user comprises means for receiving the sequence of user values from an input device of a computer system of the user, wherein the non plain-text parameters in the sequence of user values consist of non plain-text parameters of the input device, and wherein the input device is a mouse.

14. The system of claim 11, wherein an agent distinct from the application performs said receiving, said generating, and said determining.

15. The system of claim 14, wherein the agent and the application are comprised by different computing systems.

16. A computer program product, comprising a computer usable medium having a computer readable program that when executed on a computer causes the computer to perform a method for password validation, said method comprising:
receiving, from a user, a user identifier (ID), a user password, and a sequence of user values, the user password consisting of plain text characters, the sequence of user values consisting of at least one non plain-text parameter associated with each plain-text character of the user password;
appending the user password to the sequence of user values to form a user password string;
hashing the user password string to form a user digest; and
determining whether the user digest is equal to a reference digest, said reference digest being configured in accordance with password validation rules, said password validation rules specifying an expected value for said at least one non plain-text parameter associated with each plain-text character of the user password.

17. The computer program product of claim 16, wherein said receiving the sequence of user values from the user comprises receiving the sequence of user values from an input device of a computer system of the user, wherein the non plain-text parameters in the sequence of user values consist of non plain-text parameters of the input device, and wherein the input device is a keyboard.

18. The computer program product of claim 16, wherein said receiving the sequence of user values from the user comprises receiving the sequence of user values from an input device of a computer system of the user, wherein the non plain-text parameters in the sequence of user values consist of non plain-text parameters of the input device, and wherein the input device is a mouse.

19. The computer program product of claim 16, wherein an agent distinct from the application performs said receiving, said generating, and said determining.

20. The computer program product of claim 19, wherein the reference digest is stored in a table of the agent, and wherein the method further comprises:
receiving by the agent an updated reference digest from the application; and
replacing the stored reference digest in the table by the updated reference digest.
